(19) United States
(12) Patent Application Publication
(10) Pub. No.: US 2026/0299814 A1
(43) Pub. Date: Oct. 1, 2026

(54) INFORMATION PROCESSING APPARATUS AND INFORMATION PROCESSING METHOD

(71) Applicant: Hitachi Vantara, Ltd., Yokohama-shi (JP)

(72) Inventor: Tomoya OOTA, Tokyo (JP)

(73) Assignee: Hitachi Vantara, Ltd., Yokohama-shi (JP)

(21) Appl. No.: 19/310,668

(22) Filed: Aug. 26, 2025

(30) Foreign Application Priority Data
Mar. 28, 2025 (JP) 2025-055438

(51) Int. Cl. G06F 3/06

(52) U.S. Cl. CPC G06F 3/065; G06F 3/0604; G06F 3/0665; G06F 3/0673

(57) ABSTRACT

An information processing apparatus obtains, from an external apparatus, path/volume information indicating correspondence between a path used in accessing a replication source volume used by software of a replication source server and the replication source volume, transmits, to a storage apparatus, a request to create a replication destination volume to be used by a replication destination server, receives, from the storage apparatus, replication destination volume information identifying the replication destination volume, generates mapping information indicating correspondence between the path and the replication destination volume, on the basis of the path/volume information and the replication destination volume information, stores server setting information used to deploy the replication destination server in a server environment, on the basis of the mapping information, and updates information identifying the replication source volume in the server setting information to the information identifying the replication destination volume.

### BACKGROUND OF THE INVENTION

### 1. Field of the Invention

The present invention relates to an information processing apparatus and an information processing method.

### 2. Description of the Related Art

U.S. Published Application No. 2021-0240369 (hereinafter, referred to as Patent Document 1) describes a storage virtualization system in a container environment, the storage virtualization system presenting, to a container orchestrator, a virtual persistent volume storage class that includes parameters describing an associated virtual storage policy, receiving a persistent volume provisioning request that identifies the virtual persistent volume storage class, and creating a virtual persistent volume in response to the persistent volume provisioning request.

### SUMMARY OF THE INVENTION

The utilization of a container technology has spread in recent years. Also in a storage system in which a host apparatus uses volumes of a storage apparatus, an application operating in the host apparatus is often deployed and operated as a container.

In the operation of the container, a copy of the container may be created for a purpose of, for example, the construction of a test environment or improvement in development efficiency.

In this case, when the container deployed in the container environment of the host apparatus uses volumes of the storage apparatus, a configuration of volumes to be used by a replication destination container needs to be matched to a configuration at a replication source. An administrator of the system is therefore forced to perform complex work.

In addition, the above-described problem is not limited to the case where the container in the host apparatus uses volumes of the storage apparatus, and can also occur in a case of intending to replicate another type of server deployed in the host apparatus, such as a virtual server deployed in the host apparatus 100 or a physical server deployed in the host apparatus, for example.

Incidentally, while Patent Document 1 describes the creation of a virtual persistent volume in response to a persistent volume provisioning request in the container environment, Patent Document 1 does not describe a mechanism for reducing a burden imposed on the administrator in replicating a container.

The present invention has been made on the basis of such a background. It is an object of the present invention to provide an information processing apparatus and an information processing method that make it possible to easily replicate a server using volumes of a storage apparatus.

### SUMMARY OF THE INVENTION

According to one aspect of the present invention for achieving the above-described object, there is provided an information processing apparatus for assisting in replication of a server configured to use a volume that is a provision unit of a storage area in the storage apparatus and deployed in a server environment of an external apparatus in which the server operates, the replication being performed in a storage system including a storage apparatus configured to input or output data to or from a storage device in response to an input/output request sent from the external apparatus and the external apparatus, the information processing apparatus being communicably connected to the external apparatus and the storage apparatus, and the information processing apparatus being configured to obtain, from the external apparatus, path/volume information that is information indicating correspondence between a path used in accessing a replication source volume that is the volume configured to be used by software configured to be executed by a replication source server that is a server as a replication source and the replication source volume, transmit, to the storage apparatus, a request to create a replication destination volume that is a volume corresponding to the replication source volume, the replication destination volume being configured to be used by a replication destination server that is a server as a replication destination, receive replication destination volume information that is information identifying the replication destination volume, the replication destination volume information being sent from the storage apparatus in response to the creation request, generate mapping information that is information indicating correspondence between the path and the replication destination volume, on the basis of the path/volume information and the replication destination volume information, store server setting information that is setting information in the server environment of the replication destination server, and update information identifying the replication source volume in the server setting information to the information identifying the replication destination volume on the basis of the mapping information.

Problems, configurations, and effects in addition to those described above will be made apparent by the following description of a mode for carrying out the invention.

According to the present invention, it is possible to easily replicate the server that uses the volume of the storage apparatus.

### BRIEF DESCRIPTION OF THE DRAWINGS

FIG. 1 is a diagram illustrating a schematic configuration of a storage system;

FIG. 2A is a diagram illustrating an example of a container replicating procedure;

FIG. 2B is a diagram of assistance in explaining a container replicating method;

FIG. 3A is a diagram of assistance in explaining main functions that a host apparatus has;

FIG. 3B is a diagram of assistance in explaining main functions that a storage apparatus has;

FIG. 3C is a diagram of assistance in explaining main functions that a container operation managing apparatus has;

FIG. 3D is a diagram of assistance in explaining main functions that a storage cooperating apparatus has;

FIG. 4A represents an example of path obtaining method information;

FIG. 4B represents an example of path/volume information;

FIG. 4C represents an example of mapping information;

FIG. 5A is a flowchart of assistance in explaining replication destination container deployment processing;

FIG. 5B is a flowchart of assistance in explaining path/volume information obtainment processing;

FIG. 5C is a flowchart of assistance in explaining replication source usage path identification processing;

FIG. 5D is a flowchart of assistance in explaining replication source volume configuration obtainment processing;

FIG. 5E is a flowchart of assistance in explaining replication destination volume creation processing;

FIG. 5F is a flowchart of assistance in explaining container setting information update processing;

FIG. 6A represents an example of container setting information before being changed for a replication destination container;

FIG. 6B represents an example of logical volume setting processing;

FIG. 6C represents an example of the path/volume information of the replication destination container after the logical volume setting processing is performed;

FIG. 7 is a flowchart of assistance in explaining backup/restoration processing;

FIG. 8 represents an example of backup management information; and

FIG. 9 represents an example of an information processing apparatus used for a configuration of the host apparatus, the container operation managing apparatus, and the storage cooperating apparatus.

### DESCRIPTION OF THE PREFERRED EMBODIMENT

An embodiment of the present invention will hereinafter be described with reference to the drawings. Incidentally, the following embodiment is merely illustrative for describing the present invention, and is subjected to omission and simplification as appropriate for the clarification of the description. In addition, the present invention can be carried out also in various other modes. Unless specifically noted, each constituent element may be singular or plural.

In the following description, when there are a plurality of configurations having a common function, the configurations may be described with different suffixes (alphabetic characters or the like) attached to the same reference character in order to distinguish the configurations from each other. In addition, when the plurality of configurations do not particularly need to be distinguished from each other, the plurality of configurations may be described with the suffixes omitted.

In the following description, a character “S” attached to the front of a reference character denotes a processing step.

In the following description, a description may be made using such an expression as “information” or “data.” The “information” may be expressed by a data structure such as a “table,” a “list,” or a “queue,” for example.

In the following description, a description may be made using an expression “identification information.” The “identification information” can be replaced with another expression such as an “identifier,” a “name,” an “ID,” or a “number.”

In the following description, a description may be made of processing performed by an information processing apparatus (an arithmetic apparatus or a computer) executing a program. Incidentally, it suffices for a program execution entity to function as at least an arithmetic unit. For example, a processor (for example, a central processing unit (CPU), a micro processing unit (MPU), a graphics processing unit (GPU), an artificial intelligence (AI) chip, or the like) is the execution entity. In addition, the program execution entity may also be, for example, an application specific integrated circuit (ASIC), a field programmable gate array (FPGA), a complex programmable logic device (CPLD), or the like.

In the following description, data input and output (Input/Output) may be denoted as “I/O,” an interface (InterFace) may be denoted as an “I/F,” and an operating system may be denoted as an “OS.”

In addition, for terms used in the following description, terms which are used in claims and correspond to the terms used in the following description may be presented in parentheses.

### Information Processing System

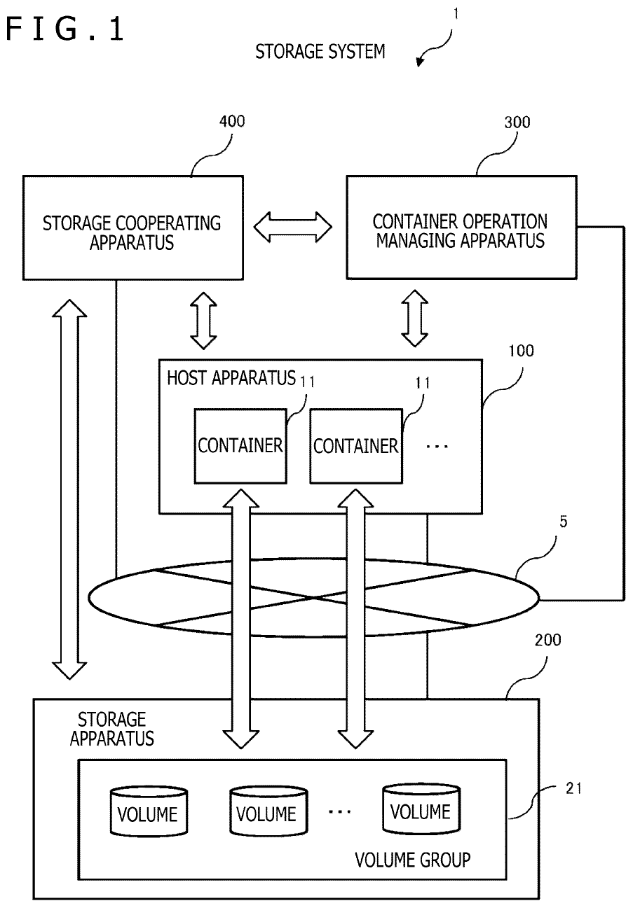

FIG. 1 illustrates a schematic configuration of an information processing system (hereinafter referred to as a “storage system 1”) illustrated as one embodiment. The illustrated storage system 1 includes a host apparatus 100, a storage apparatus 200, a container operation managing apparatus 300 (server operation managing apparatus), and a storage cooperating apparatus 400.

The host apparatus 100, the storage apparatus 200, the container operation managing apparatus 300, and the storage cooperating apparatus 400 are connected to one another in a state of being capable of mutual two-way communication via a communication network 5.

The communication network 5 is, for example, a local area network (LAN), a wide area network (WAN), the Internet, various types of public communication networks, a dedicated line, and the like. The host apparatus 100 and the storage apparatus 200 may be connected to each other via a storage network (storage area network (SAN)).

The host apparatus 100 (referred to also as an “external apparatus,” a “higher level apparatus,” or the like) is an information processing apparatus that uses, as a data storage (memory) location, a storage area provided by the storage apparatus 200 via the communication network 5.

In the host apparatus 100, an operating system (hereinafter referred to as a “host OS”) operates. Under management of the host OS, a container operation base (container engine) (server operation base) which provides an execution environment of a container 11 illustrated as an example of a server that operates in the host apparatus 100 (which environment will hereinafter be referred to as a “container environment” (server environment)) operates.

The container 11 is deployed in the container environment on the basis of a container image (server image) in which elements (an application main body, run-time software, a dependent module, and the like) necessary for the execution of one or more pieces of software (application software or the like; hereinafter referred to as “container software” (server software)) are built.

The container operation base performs start management (a start, a stop, and a restart) of the container 11, construction and management of the container environment, monitoring of container operation, and the like. An example of the container operation base is “Docker (registered trademark).” Each container 11 deployed in the container environment of the host apparatus 100 is distinguished by a “container ID.”

The storage apparatus 200 includes a control device and a storage device that is controlled by the control device. The storage apparatus 200 may be provided by a cloud system via the communication network 5 (cloud storage).

The above-described control device includes a processor, a memory module, a communication I/F, and a drive I/F.

The processor is configured by use of an arithmetic core, a cache memory, direct memory access (DMA), and the like. The memory module is, for example, a dual in-line memory module (DIMM), and is configured by use of a volatile storage element such as a dynamic random access memory (DRAM).

The communication I/F communicates with another apparatus (not illustrated) using the storage apparatus 200, such as a client device or a user device, via the communication network 5 or the like.

The drive I/F performs processing related to data transfer to and from the storage device at a time of the reading of data from the storage device to the memory module or the writing of data from the memory module to the storage device.

The control device accesses the storage device in response to an I/O request sent from another apparatus, and returns a result thereof to the another apparatus.

The storage device has one or more physical drives as a recording medium that provides a physical storage area. The physical drive(s) is (are) configured by use of a recording medium such as a solid state drive (SSD: semiconductor storage device), a hard disk drive (HDD: hard disk device), or the like, for example.

The storage apparatus 200, in which a storage area configured by use of the physical drive(s) (which storage area will hereinafter be referred to as a “physical volume”) is set as a unit, provides the storage area to the host apparatus 100.

The physical volume of the storage apparatus 200 that stores data used by the container 11 is associated with a path of a file system (a file path or a directory path).

Incidentally, the correspondence between the path and the physical volume is not necessarily one-to-one correspondence, and one path may be associated with a logical storage area constituted by a plurality of physical volumes (which logical storage area will hereinafter be referred to as a “logical volume”).

In the following, when the physical volume and the logical volume do not need to be distinguished from each other, these may be referred to collectively as “volumes.” In addition, suppose that each volume is distinguished by a “volume ID.” In addition, suppose that the container 11 deployed in the container environment of the host apparatus 100 can use a storage area provided by the storage apparatus 200, with a volume as a unit.

The container operation managing apparatus 300 is an information processing apparatus that performs orchestration of containers operating in the host apparatus 100 (deployment of the containers, execution management of the plurality of containers, scaling, load distribution, and the like). An example of software that implements functions of the container operation managing apparatus 300 is “Kubernetes (registered trademark).” All or some of the functions of the container operation managing apparatus 300 may be implemented by the container operation base of the host apparatus 100, for example.

The storage cooperating apparatus 400 is an information processing apparatus that implements various types of functions for acting as a bridge between the container operation managing apparatus 300 and the storage apparatus 200. Incidentally, details of functions of the storage cooperating apparatus 400 will be described later.

### Container Replicating Function

The container operation managing apparatus 300 (or the container operation base of the host apparatus 100) has a function of replicating the container 11 deployed in the container environment of the host apparatus 100. An administrator of the container 11 (which administrator will hereinafter be referred to as a “container administrator” (server administrator)) replicates the container 11 by using the replicating function, for example, in a case where the administrator desires to construct a test environment for the container software, a case where the administrator desires to prepare a system serving as a backup of the container 11 in preparation for a disaster or the like, a case where the administrator desires to use data used by the existing container in another container 11, a case where the administrator desires to transfer the container software to a container environment with a higher performance or a higher capacity in order to resolve a lack of performance or a lack of capacity of the existing container 11, or the like.

Here, at a time when the container 11 is to be replicated by the above-described replicating function when the container software operating in the container 11 corresponding to a replication source uses volumes in the storage apparatus 200, a configuration of volumes to be used by a container 11 corresponding to a replication destination needs to be matched to a configuration of the volumes used by the replication source container 11. The replication of the container 11 therefore needs to be performed by the following procedure, for example.

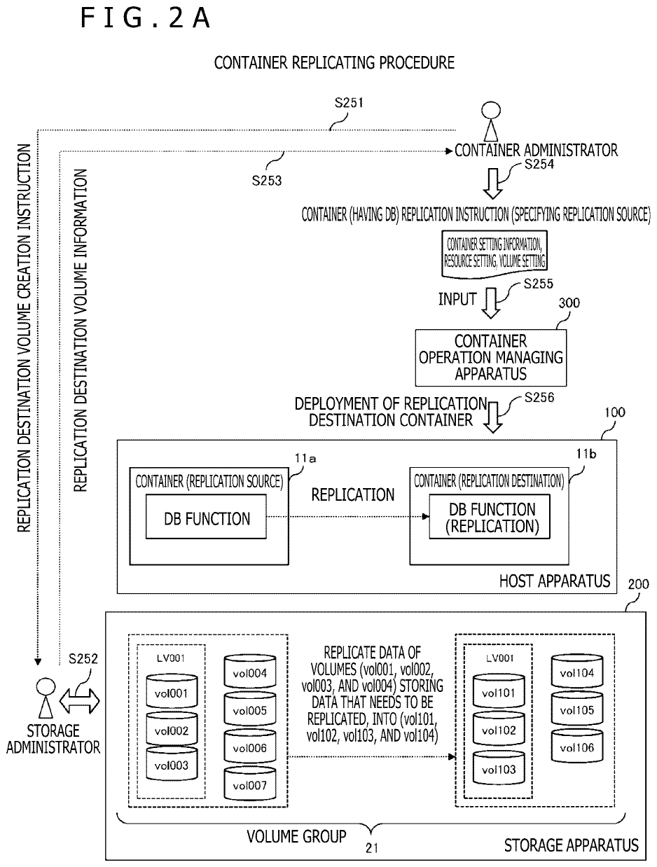

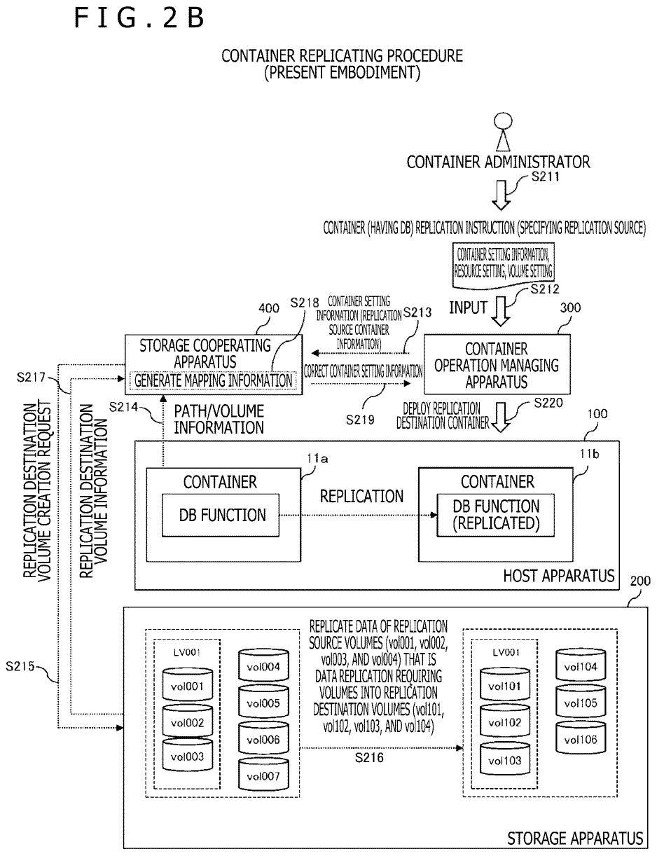

FIG. 2A is a diagram illustrating an example of the procedure. In the following, the container 11 as the replication source will be referred to as a “container 11a,” and the container 11 as the replication destination will be referred to as a “container 11b.”

As illustrated in the figure, first, the container administrator sends, to a storage administrator, a request to create volumes to be used by the replication destination container 11b (S251). At this time, in sending the above-described request, the container administrator identifies volumes used by the replication source container software (which volumes will hereinafter be referred to as “replication source volumes”) and volumes storing data that needs to be replicated in advance (which volumes will hereinafter be referred to as “data replication requiring volumes”), among the volumes used by the replication source container software, into volumes to be used by the replication destination container 11b. Moreover, in the above-described creation request, the container administrator gives the storage administrator an instruction (hereinafter referred to as a “replication destination volume creation instruction”) including an instruction to create the volumes to be used by the replication destination container 11b (which volumes will hereinafter be referred to as “replication destination volumes”), the volumes corresponding to the identified replication source volumes, and an instruction to replicate the data of the data replication requiring volumes into the corresponding replication destination volumes.

Receiving the above-described notification, the storage administrator operates the storage apparatus 200 to create the replication destination volumes in the storage apparatus 200. In addition, the storage administrator operates the storage apparatus 200 to replicate the data of the data replication requiring volumes into the corresponding replication destination volumes (S252).

Next, the storage administrator notifies the container administrator of information indicating the created replication destination volumes (which information will hereinafter be referred to as “replication destination volume information”) (S253).

Receiving the above-described notification, the container administrator generates information (hereinafter referred to as “container setting information”) including a container replication instruction and the replication destination volume information (S254), and inputs the generated container setting information to the container operation managing apparatus 300 (S255). Incidentally, the container setting information includes not only the above-described information but also information specifying resources of the replication destination container 11b (processor performance, memory performance, size, and the like), for example.

When the container setting information is input to the container operation managing apparatus 300, the container operation managing apparatus 300 deploys the replication destination container 11b in the host apparatus 100 according to the container setting information (S256).

Here, when the replication of the container 11 is performed according to the above procedure, the container administrator needs to identify the replication destination volumes and the data replication requiring volumes and notify the storage administrator of the creation request. In addition, the storage administrator needs to create the replication destination volumes to replicate the data of the replication requiring volumes, in response to the above-described creation request, and notify the container administrator of the replication destination volume information. In addition, the container administrator needs to generate the container setting information on the basis of the replication destination volume information of which the storage administrator gives a notification. Thus, the container administrator and the storage administrator are forced to perform complex work when performing the replication of the container 11 by the above procedure.

In view of this, the storage system 1 according to the present embodiment achieves a reduction in burdens imposed on the container administrator and the storage administrator in replicating the container 11, by enabling the container replication by a procedure illustrated in the following.

FIG. 2B is a diagram of assistance in explaining a method performed by use of the storage system 1 according to the present embodiment to replicate the container 11 which method is.

First, the container administrator generates container setting information describing setting information of a container for deploying the replication destination container 11b in the container environment of the host apparatus 100 (S211), and inputs the generated container setting information to the container operation managing apparatus 300 (S212).

When the container setting information is input to the container operation managing apparatus 300, the container operation managing apparatus 300 notifies the storage cooperating apparatus 400 of the input container setting information together with information about the replication source container 11a (which information is the container ID of the replication source container 11 in the present example, and will hereinafter be referred to as “replication source container information”) (S213). This notification is performed by use of a hook function of the container operation managing apparatus 300, for example. Incidentally, even when the container setting information is input to the container operation managing apparatus 300, the container operation managing apparatus 300 does not transmit an instruction to create the replication destination container 11b to the host apparatus 100, until the storage cooperating apparatus 400 completes updating of the container setting information as described later.

Receiving the above-described notification, the storage cooperating apparatus 400 obtains, from the container management base of the host apparatus 100, information about volumes (replication source volumes) used by the replication source container 11a identified by the replication source container information (which information about the volumes is information indicating correspondence between paths used when the container software of the replication source container 11a accesses the replication source volumes and the replication source volumes, and will hereinafter be referred to as “path/volume information”) (S214). Incidentally, the path/volume information is managed for each container 11 in the host apparatus 100.

The storage cooperating apparatus 400 identifies the replication source volumes from the obtained path/volume information, and identifies, among the identified replication source volumes, volumes storing data that needs to be replicated in advance (which volumes will hereinafter be referred to as “data replication requiring volumes”) into volumes to be used by the replication destination container 11b. Then, the storage cooperating apparatus 400 transmits, to the storage apparatus 200, a request (hereinafter referred to as a “replication destination volume creation request”) including a request to create volumes to be used by the replication destination container 11b (which volumes will hereinafter be referred to as “replication destination volumes”), the volumes corresponding to the identified replication source volumes, and a request to replicate the data of the data replication requiring volumes into the corresponding replication destination volumes (S215).

Incidentally, the storage cooperating apparatus 400 identifies the data replication requiring volumes on the basis of information which indicates the data replication requiring volumes and which is prepared and stored in advance, for example. For example, in a case where the container software is a database system (data base management system (DBMS); hereinafter referred to as a “DB”), the storage cooperating apparatus 400 identifies, as a data replication requiring volume, a volume storing a transaction or a volume storing information necessary to manage data stored in volumes, and does not identify a volume storing log information as a data replication requiring volume.

In addition, in a case where the container software of the replication source container 11a includes a DB, the storage cooperating apparatus 400 transmits a request to secure a quiescent point of the DB to the replication source container 11a in the host apparatus 100, before transmitting the replication destination volume creation request to the storage apparatus 200, and transmits the replication destination volume creation request to the storage apparatus 200 after confirming that the quiescent point of the DB is secured.

Receiving the replication destination volume creation request, the storage apparatus 200 creates the replication destination volumes in the storage apparatus 200. In addition, the storage apparatus 200 replicates the data of the data replication requiring volumes into the corresponding replication destination volumes (S216).

Next, the storage apparatus 200 transmits information indicating the replication destination volumes (which information will hereinafter be referred to as “replication destination volume information”) to the storage cooperating apparatus 400 (S217).

Receiving the replication destination volume information, the storage cooperating apparatus 400 generates information indicating correspondence between the paths used by the container software, the volume IDs of the replication source volumes, and the volume IDs of the replication destination volumes (which information will hereinafter be referred to as “mapping information”), on the basis of the received replication destination volume information and the path/volume information obtained in S214 (S218).

Next, the storage cooperating apparatus 400 updates the container setting information on the basis of the mapping information such that a configuration of the replication destination volumes to be used by the container 11b is matched to a configuration of the replication source volumes used by the container 11a.

In addition, when a replication source volume constitutes a logical volume, the storage cooperating apparatus 400 generates processing for setting the logical volume to be used by the replication destination container 11b (which processing will hereinafter be referred to as “logical volume setting processing”), the processing being automatically performed by the container 11b at a time of deployment of the replication destination container 11b or at a time of starting of the container 11b, and adds the generated logical volume setting processing to the container setting information (S219).

Thereafter, the container operation managing apparatus 300 deploys the replication destination container 11b in the container environment of the host apparatus 100 on the basis of the container setting information updated in S219 (S220).

As described above, the storage system 1 according to the present embodiment automatically performs the work performed by the container administrator and the storage administrator in the procedure of FIG. 2A, when a container 11 is to be replicated by the above-described replicating function in a case where the container software operating in the replication source container 11 uses volumes in the storage apparatus 200. It is therefore possible to greatly reduce burdens on the container administrator and the storage administrator.

### Host Apparatus

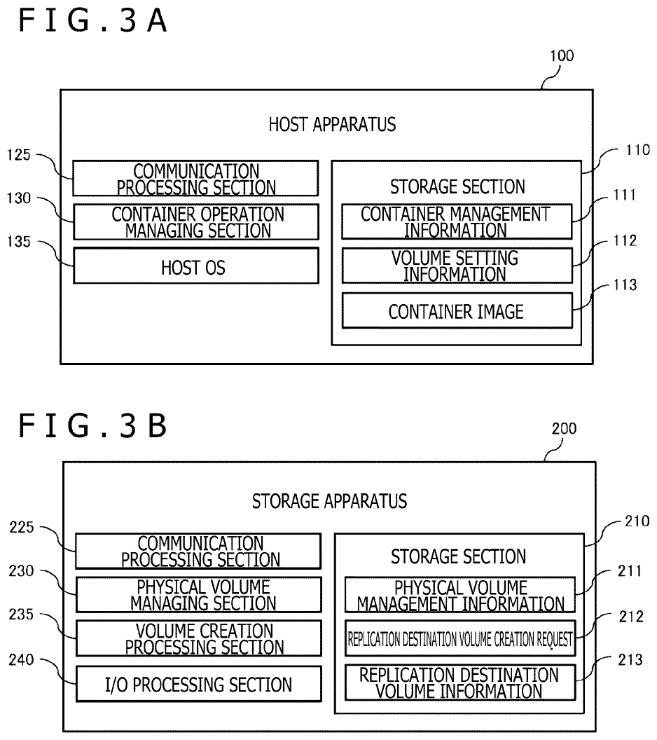

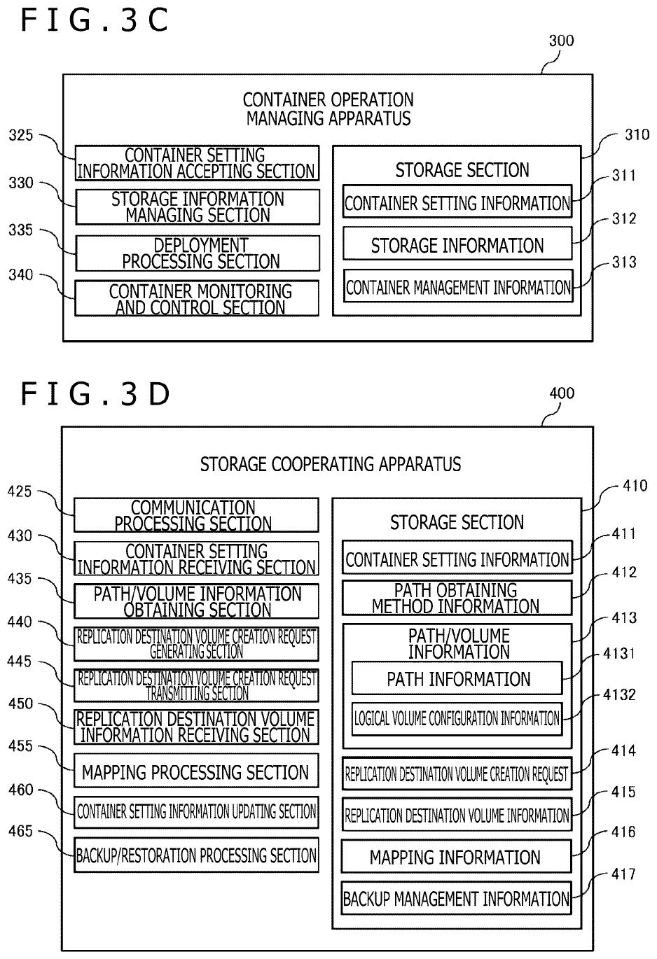

FIG. 3A is a diagram (block diagram) of assistance in explaining main functions that the host apparatus 100 has. As illustrated in the figure, the host apparatus 100 has respective functions of a storage section 110, a communication processing section 125, a container operation managing section 130, and a host OS 135.

The storage section 110 stores container management information 111, volume setting information 112, and a container image 113.

The container management information 111 is information managed by the container operation managing section 130, and includes various types of information used for operation and management of the containers 11. The above-described information includes, for example, information related to creation and deletion of a container 11, information related to starting and stopping of the container 11, information indicating a storage destination of a container image, the data size of the container image, network settings of the container 11 (a setting of a network address such as an internet protocol (IP) address, a domain name system (DNS) setting, and the like), log information (an execution log of the container 11, a system log, an audit log, and the like), monitoring information (resource usage conditions, a load state, and the like) of the container 11, information (access control information, authentication information, and the like) related to security management of the container 11, information related to various types of orchestration, and the like.

The volume setting information 112 is information related to the volumes of the storage apparatus 200 used by each container 11 operated under the container operation managing section 130. The volume setting information 112 includes, for example, information corresponding to the path/volume information described above.

The container image 113 includes an entity of the container 11 (base layer configuration information, application layer configuration information, metadata, registry information, and the like). The container image 113 is stored into the host apparatus 100 via the container operation managing apparatus 300 or a user interface, for example.

The communication processing section 125 performs communication with the container operation managing apparatus 300 and the storage cooperating apparatus 400. The communication processing section 125 transmits an I/O request to the storage apparatus 200. In addition, the communication processing section 125 receives a notification of completion of the writing of data to a volume or data read from a volume, the notification or the read data being sent from the storage apparatus 200 in response to the above-described I/O request.

The container operation managing section 130 includes functions of the above-described container operation base, and performs various types of processing related to operation and management of the containers 11. Performed as the above-described processing are creation and deletion of a container 11, starting and stopping of the container 11, control of communication performed between the containers 11 and with another apparatus, management of an execution log of the container 11, monitoring of the container 11, various types of control related to security management of the container 11, and other control related to orchestration. The container operation managing section 130 manages, as the container management information 111 in the storage section 110, information used for the operation and management of the containers 11.

The host OS 135 performs control and monitoring of hardware of the host apparatus 100 and software operating in the hardware. In addition, the host OS 135 provides the containers 11 with various types of resources. The above-described resources include, for example, a processor, a storage area (including a memory and the volumes of the storage apparatus 200), kernel functions (process management, memory management, network management, and the like), a container run-time execution environment, a function of separating resources between the containers 11, a function of communication between the containers 11 and with an external system, and the like.

### Storage Apparatus

FIG. 3B is a diagram of assistance in explaining main functions that the storage apparatus 200 has (block diagram). As illustrated in the figure, the storage apparatus 200 has respective functions of a storage section 210, a communication processing section 225, a physical volume managing section 230, a volume creation processing section 235, and an I/O processing section 240.

The storage section 210 stores physical volume management information 211, a replication destination volume creation request 212, and replication destination volume information 213.

The physical volume management information 211 includes information related to physical volumes that can be provided by the storage apparatus 200 (volume IDs, performance and capacity, information about constituent physical drives, and the like).

The replication destination volume creation request 212 is the above-described replication destination volume creation request sent from the storage cooperating apparatus 400. The replication destination volume creation request 212 includes information indicating the volumes ID of the replication source volumes and the volume IDs of the data replication requiring volumes.

The replication destination volume information 213 is the replication destination volume information described above. The replication destination volume information 213 includes information indicating the volume IDs of the replication destination volumes.

The communication processing section 225 performs communication with the host apparatus 100 and the storage cooperating apparatus 400. The communication processing section 225 transmits the replication destination volume information and backup information to the storage cooperating apparatus 400. In addition, the communication processing section 225 performs reception of an I/O request sent from the host apparatus 100, transmission of response information in response to the I/O request to the host apparatus 100, and the like.

The physical volume managing section 230 manages, as the physical volume management information 211, information related to the physical volumes that can be provided by the storage apparatus 200.

The volume creation processing section 235 creates the replication destination volumes and replicates the data of the data replication requiring volumes into the replication destination volumes on the basis of the replication destination volume creation request received from the storage cooperating apparatus 400.

The I/O processing section 240 performs such processing as reading data stored in a volume or writing data to a volume according to an I/O request sent from the host apparatus 100.

### Container Operation Managing Apparatus

FIG. 3C is a diagram of assistance in explaining main functions that the container operation managing apparatus 300 has (block diagram). As illustrated in the figure, the container operation managing apparatus 300 has respective functions of a storage section 310, a container setting information accepting section 325, a storage information managing section 330, a deployment processing section 335, and a container monitoring and control section 340.

The storage section 310 stores container setting information 311, storage information 312, and container management information 313.

The container setting information 311 is the above-described container setting information accepted from the container administrator by the container setting information accepting section 325. The container setting information 311 includes resource setting information and volume setting information.

Of these pieces of setting information, the resource setting information includes information related to the resources of the host apparatus 100 used by the container 11 (the performance of a processor, the performance and capacity of a memory, the type and performance of a communicating device, and the like). In addition, the volume setting information includes information related to the volumes of the storage apparatus 200 used by the container 11 (the volume IDs, the performance of the volumes, the capacity of the volumes, and the like).

The storage information 312 includes information related to the volumes provided by the storage apparatus 200 (the volume IDs, the performance and capacity of the volumes, configurations of logical volumes (correspondence with physical volumes), and the like).

The container management information 313 includes various types of information used by the container monitoring and control section 340 for operation and management of the containers 11.

The container setting information accepting section 325 accepts an input of container setting information from the container administrator, and manages the accepted container setting information as the container setting information 311 in the storage section 310. In addition, when accepting the input of the container setting information, the container setting information accepting section 325 transmits the accepted container setting information and the above-described replication source container information to the storage cooperating apparatus 400. The above-described transmission is performed by use of a hook function, for example.

The storage information managing section 330 manages information related to the volumes that can be provided to the host apparatus 100 by the storage apparatus 200, as the storage information 312 in the storage section 310.

The deployment processing section 335 deploys a container 11 in the container environment of the host apparatus 100 on the basis of the container setting information 311. In deploying the container 11, the deployment processing section 335 makes various types of settings (OS settings, mounting of volumes into the container, a volume driver setting, and the like) that are necessary for the container 11 to access volumes in the storage apparatus 200, on the basis of the container setting information 311.

The container monitoring and control section 340 performs processing related to monitoring and control of the container 11 deployed in the host apparatus 100. The above-described processing includes, for example, creation and deletion of the container, starting and stopping of the container, control of communication between containers and with another apparatus, management of log information, monitoring of the container, various types of control related to security of the container, and control related to orchestration. The container monitoring and control section 340 manages information used for the above-described processing, as the container management information 313 in the storage section 310. Incidentally, the container monitoring and control section 340 may be configured to, for example, manage the container management information 313 in cooperation with the container operation managing section 130 of the host apparatus 100.

### Storage Cooperating Apparatus

FIG. 3D is a diagram of assistance in explaining main functions that the storage cooperating apparatus 400 has (block diagram). As illustrated in the figure, the storage cooperating apparatus 400 has respective functions of a storage section 410, a communication processing section 425, a container setting information receiving section 430, a path/volume information obtaining section 435, a replication destination volume creation request generating section 440, a replication destination volume creation request transmitting section 445, a replication destination volume information receiving section 450, a mapping processing section 455, a container setting information updating section 460, and a backup/restoration processing section 465.

The storage section 410 stores container setting information 411, path obtaining method information 412, path/volume information 413, a replication destination volume creation request 414, replication destination volume information 415, mapping information 416, and backup management information 417.

The container setting information 411 is the container setting information described above. The container setting information 411 includes the replication source container information described above.

The path obtaining method information 412 includes information indicating a method of obtaining information about a path used when the container software of the container 11 specifies data stored in a volume of the storage apparatus 200.

The path/volume information 413 is the path/volume information described above, and includes information indicating correspondence between paths and volumes. The path/volume information 413 includes path information 4131 and logical volume configuration information 4132.

The path information 4131 includes information indicating correspondence between the paths and the volume IDs of the volumes of the storage apparatus 200 associated with these paths.

The logical volume configuration information 4132 includes information indicating correspondence between the volume ID of a logical volume and the volume IDs of physical volumes constituting the logical volume.

The replication destination volume creation request 414 is the replication destination volume creation request described above, and includes information indicating the volume IDs of the replication source volumes (volumes serving as a source of the replication destination volumes) and information indicating the volume IDs of the data replication requiring volumes.

The replication destination volume information 415 is the replication destination volume information described above, and includes information indicating the volume IDs of the replication destination volumes created as volumes corresponding to the replication source volumes by the storage apparatus 200.

The mapping information 416 includes information indicating correspondence between the paths used when the container software of the container 11 accesses the volumes, the volume IDs of the replication source volumes associated with these paths, and the volume IDs of the replication destination volumes associated with the replication source volumes.

The backup management information 417 is information used for a backup/restoration function to be described later. Details of the backup management information 417 will therefore be described later.

The communication processing section 425 performs communication with each of the host apparatus 100, the storage apparatus 200, and the container operation managing apparatus 300.

The container setting information receiving section 430 receives the container setting information and the replication source container information sent from the container operation managing apparatus 300, and manages the received container setting information and the received replication source container information as the container setting information 411 in the storage section 410.

The path/volume information obtaining section 435 obtains, from the host apparatus 100, the path/volume information of the container 11 identified by the replication source container information of the container setting information 411, and manages the obtained path/volume information as the path/volume information 413 in the storage section 410. Incidentally, the path/volume information obtaining section 435 obtains the path/volume information by a method described in the path obtaining method information 412, for example.

The replication destination volume creation request generating section 440 generates a replication destination volume creation request on the basis of the path/volume information 413, and manages the generated replication destination volume creation request as a replication destination volume creation request 414 in the storage section 410.

The replication destination volume creation request transmitting section 445 transmits the replication destination volume creation request to the storage apparatus 200.

The replication destination volume information receiving section 450 receives replication destination volume information sent from the storage apparatus 200, and manages the received replication destination volume information as the replication destination volume information 415 in the storage section 410.

The mapping processing section 455 generates the above-described mapping information on the basis of the path/volume information 413 and the replication destination volume information 415 sent from the storage apparatus 200, and manages the generated mapping information as the mapping information 416 in the storage section 410.

The container setting information updating section 460 updates the container setting information 411 on the basis of the mapping information 416, and transmits the updated container setting information 411 to the container operation managing apparatus 300.

The backup/restoration processing section 465 is a function corresponding to the backup/restoration function to be described later.

### Path Obtaining Method Information

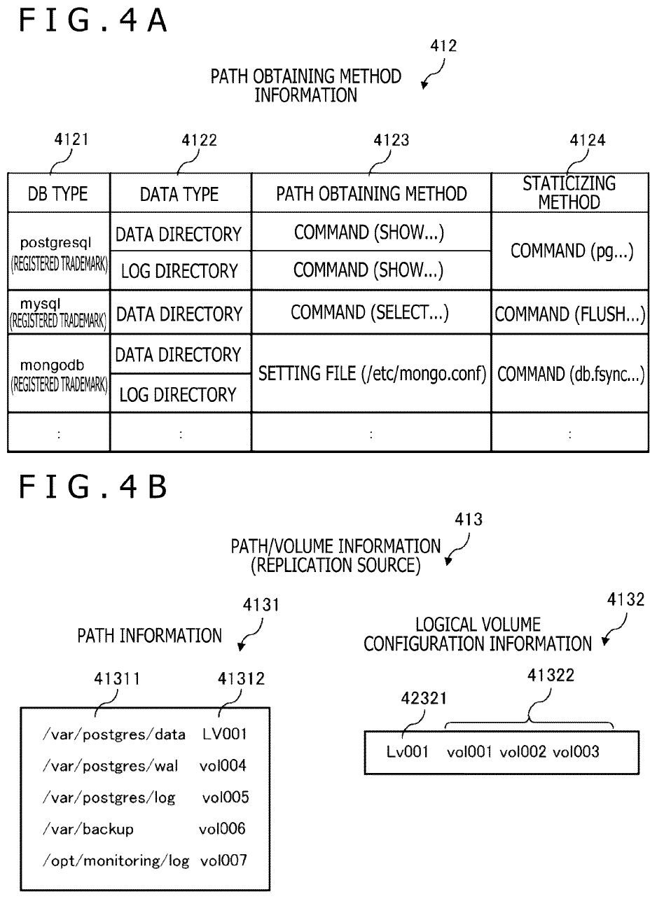

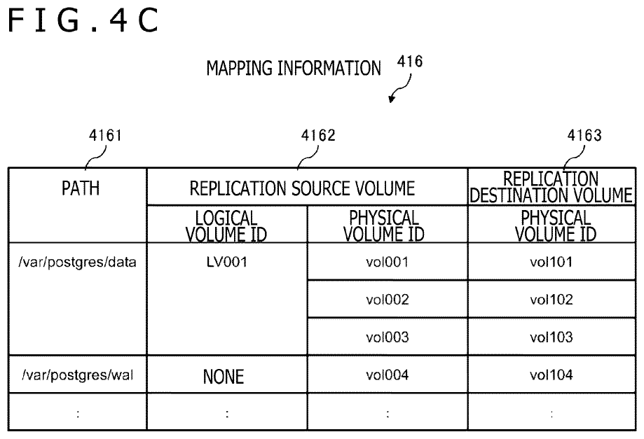

FIG. 4A illustrates an example of the path obtaining method information 412 stored by the storage section 410 of the storage cooperating apparatus 400. The figure illustrates an example of the path obtaining method information 412 in a case where the container software of the replication source container 11a is a DB.

The illustrated path obtaining method information 412 is constituted by one or more records having respective items of a DB type 4121, a data type 4122, a path obtaining method 4123, and a staticizing method 4124.

The DB type 4121 stores information indicating a type of DB (“postgresql” (registered trademark), “mysql” (registered trademark), “mongodb” (registered trademark), or the like).

The data type 4122 stores information indicating a type of data managed by the DB (a “data directory,” a “log directory,” and the like).

The path obtaining method 4123 stores information indicating a method of obtaining information about a path that is referred to when the DB accesses data.

The staticizing method 4124 stores information indicating a method of staticizing the DB.

### Path/Volume Information

FIG. 4B illustrates an example of the path/volume information 413 stored by the storage section 410 of the storage cooperating apparatus 400. The figure illustrates the path/volume information 413 obtained for the replication source container 11a in a case where the container software of the replication source container 11a is a DB. The path/volume information 413 includes the path information 4131 and the logical volume configuration information 4132.

The path information 4131 includes information indicating correspondence between a path 41311 and a volume ID 41312 (ID of a logical volume or a physical volume).

The logical volume configuration information 4132 includes information indicating correspondence between a volume ID 42321 of a logical volume and physical volumes 41322 constituting the logical volume.

### Mapping Information

FIG. 4C illustrates an example of the mapping information 416 stored by the storage section 410 of the storage cooperating apparatus 400. The figure illustrates an example of the mapping information 416 in a case where the container software of the replication source container 11a is a DB.

The illustrated mapping information 416 is constituted by one or more records having respective items of a path 4161, a replication source volume 4162, and a replication destination volume 4163.

The path 4161 stores information (path name) indicating a path that is referred to when the DB accesses data.

The replication source volume 4162 stores information indicating the volume ID of a replication source volume (a logical volume or a physical volume).

The replication destination volume 4163 stores information indicating the volume ID of a physical volume assigned to the replication destination container 11b.

### Outline of Processing

A description will next be made of processing performed in the storage system 1 constituted by the foregoing configurations.

### Container Deployment Processing

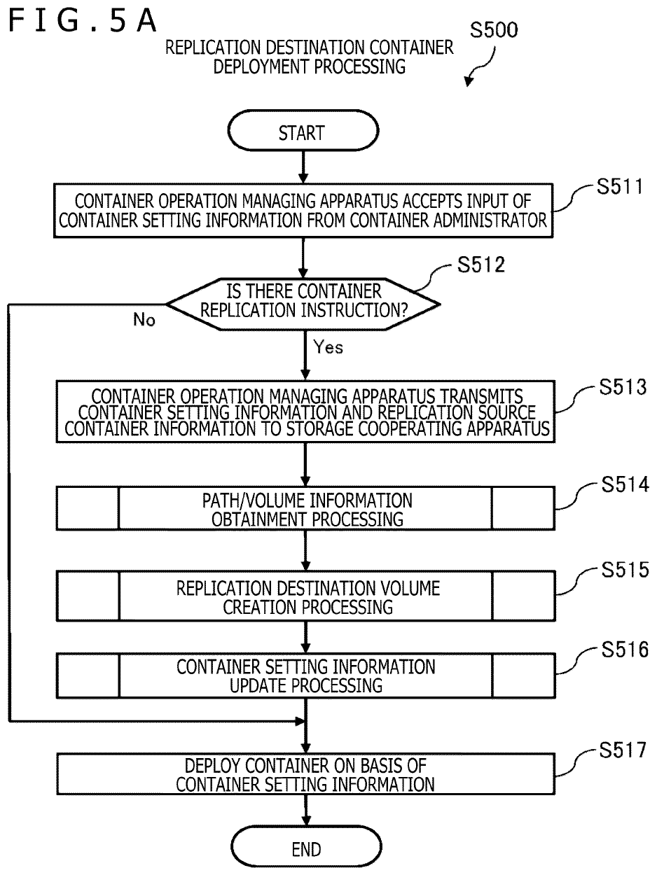

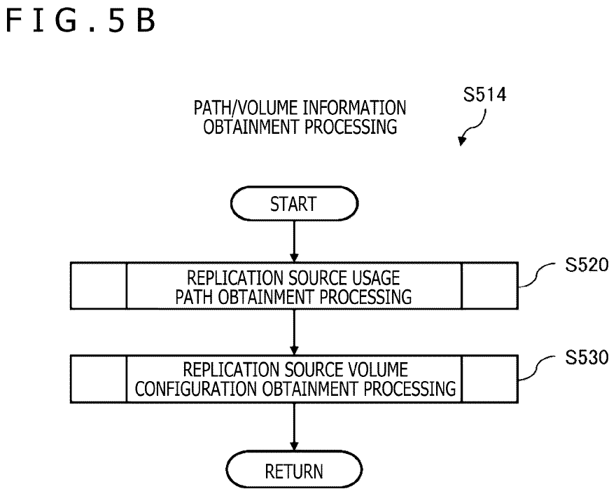

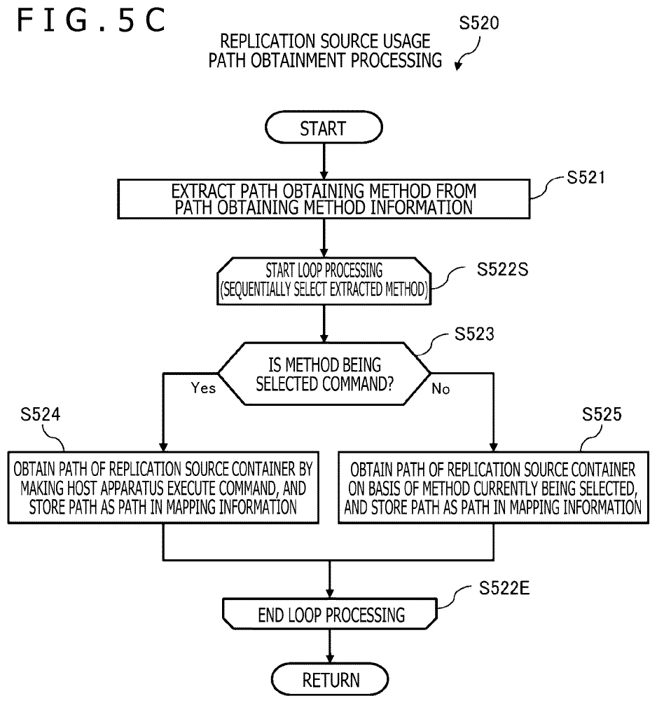

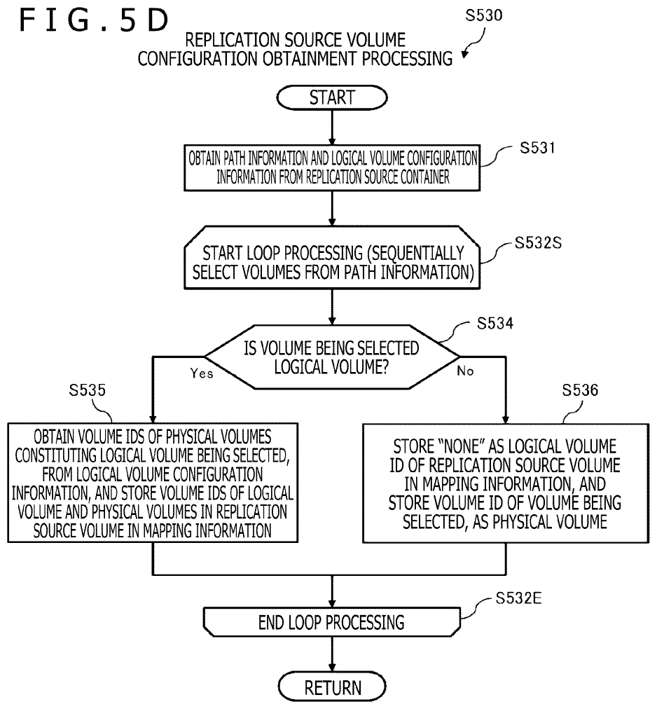

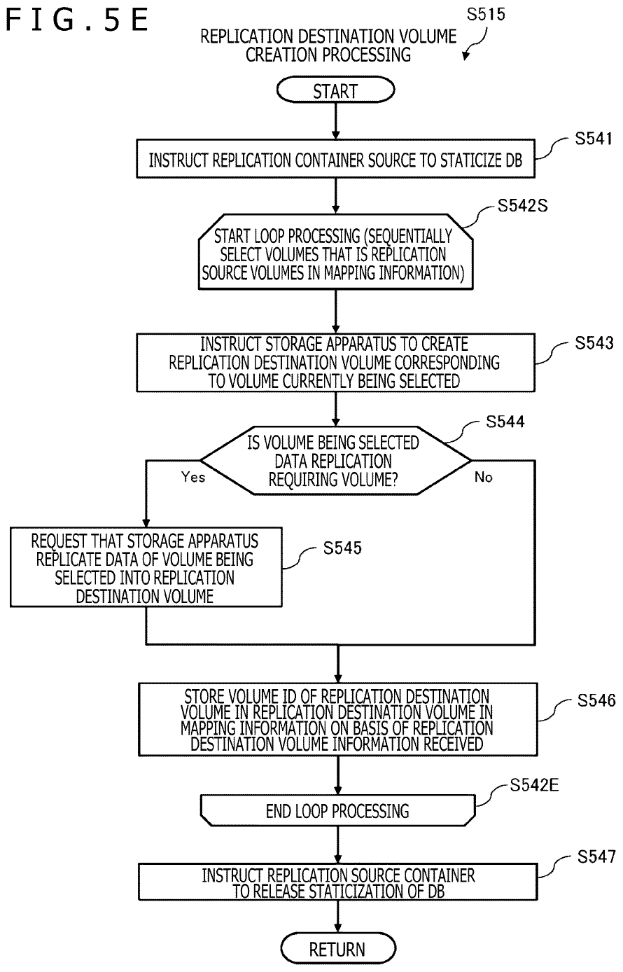

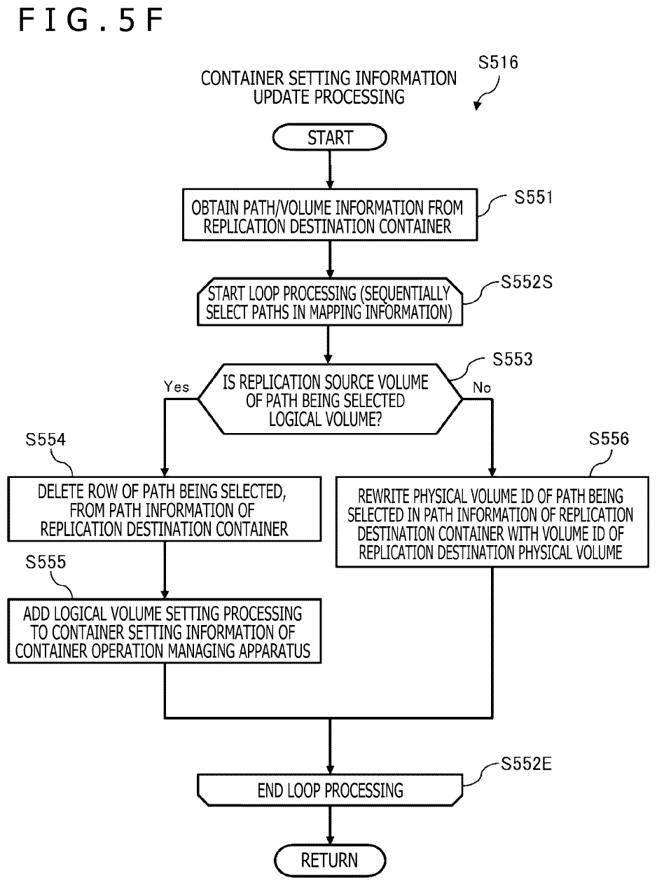

FIG. 5A is a flowchart of assistance in explaining main processing performed in the storage system 1 when the replication destination container 11b replicated from the replication source container 11a is deployed in the container environment of the host apparatus 100 (which processing will hereinafter be referred to as “replication destination container deployment processing S500”). In the following, the replication destination container deployment processing S500 will be described in conjunction with the figure.

First, the container operation managing apparatus 300 accepts an input of container setting information from the container administrator (S511).

The container operation managing apparatus 300 determines whether or not the accepted container setting information is accompanied by an instruction to replicate a container 11 (S512). The container operation managing apparatus 300 makes the above-described determination by, for example, determining whether or not an explicit replication instruction or the above-described replication source container information is attached.

When the container setting information is accompanied by an instruction to replicate a container 11 (S512: Yes), the processing proceeds to S513. When the container setting information is not accompanied by an instruction to replicate a container 11 (S512: No), on the other hand, the processing proceeds to S517.

In S513, the container operation managing apparatus 300 transmits the container setting information and the replication source container information to the storage cooperating apparatus 400.

In S514, the storage cooperating apparatus 400 performs processing of obtaining the path/volume information from the container management base of the host apparatus 100 (which processing will hereinafter be referred to as “path/volume information obtainment processing S514”). Incidentally, details of the path/volume information obtainment processing S514 will be described later.

In S515, the storage cooperating apparatus 400 and the storage apparatus 200 perform processing related to the generation of the replication destination volumes and the generation of the mapping information (which processing will hereinafter be referred to as “replication destination volume creation processing S515”). Incidentally, details of the replication destination volume creation processing S515 will be described later.

In S516, the storage cooperating apparatus 400 performs processing of updating the container setting information on the basis of the generated mapping information (which processing will hereinafter be referred to as “container setting information update processing S516”). Incidentally, details of the container setting information update processing S516 will be described later.

In S517, the container operation managing apparatus 300 deploys the replication destination container 11b in the container environment of the host apparatus 100 on the basis of the updated container setting information.

This ends the replication destination container deployment processing S500.

FIG. 5B is a flowchart of assistance in explaining the path/volume information obtainment processing S514 in FIG. 5A. As illustrated in FIG. 5B, the path/volume information obtainment processing S514 includes replication source usage path obtainment processing S520 and replication source volume configuration obtainment processing S530.

FIG. 5C is a flowchart of assistance in explaining details of the replication source usage path obtainment processing S520 in FIG. 5B.

First, the storage cooperating apparatus 400 obtains, from the path obtaining method information 412, a method of obtaining paths from the host apparatus 100 (S521).

For example, in a case where the path obtaining method information 412 has contents illustrated in FIG. 4A, the storage cooperating apparatus 400 obtains, from the path obtaining method information 412, the contents of the path obtaining method 4123 in a row in which a combination of the DB type 4121 and the data type 4122 matches a combination of the DB type and the data type of the DB that is the container software of the replication source container 11a.

The following loop processing of S522S to S522E is processing that the storage cooperating apparatus 400 repeatedly performs while sequentially selecting the method obtained in S521.

First, in S523, the storage cooperating apparatus 400 determines whether or not the method currently being selected is a method by which the host apparatus 100 is made to execute a command. When the method currently being selected is a method by which the host apparatus 100 is made to execute a command (S523: Yes), the processing proceeds to S524. When the method currently being selected is not a method by which the host apparatus 100 is made to execute a command (S523: No), on the other hand, the processing proceeds to S525.

In S524, the storage cooperating apparatus 400 obtains paths from the host apparatus 100 by making the host apparatus 100 execute the command indicated by the method currently being selected, and stores the obtained paths in the path 4161 of the mapping information.

On the other hand, in S525, the storage cooperating apparatus 400 obtains paths from the host apparatus 100 on the basis of the method currently being selected, and stores the obtained paths in the mapping information 416. For example, the storage cooperating apparatus 400 obtains the paths by referring to a setting file prepared in advance, and stores the obtained paths in the path 4161 of the mapping information 416.

The processing thereafter proceeds to S530 in FIG. 5B.

FIG. 5D is a flowchart of assistance in explaining details of the replication source volume configuration obtainment processing S530 in FIG. 5B.

First, the storage cooperating apparatus 400 accesses the host apparatus 100, and obtains the path information and the logical volume configuration information of the replication source container 11a (S531).

The following loop processing of S532S to S532E is processing that the storage cooperating apparatus 400 repeatedly performs while sequentially selecting volumes (volume IDs) from the path information obtained in S531.

First, in S534, the storage cooperating apparatus 400 determines whether or not the volume currently being selected is a logical volume. When the volume currently being selected is a logical volume (S534: Yes), the processing proceeds to S535. When the volume currently being selected is not a logical volume (S534: No), on the other hand, the processing proceeds to S536.

In S535, the storage cooperating apparatus 400 obtains, from the obtained logical volume configuration information, the volume IDs of physical volumes constituting the logical volume currently being selected, and stores the obtained volume IDs as the physical volume ID of the replication source volume 4162 of the mapping information 416. In addition, the storage cooperating apparatus 400 stores the volume ID of the volume currently being selected, as the logical volume ID of the replication source volume 4162 of the mapping information 416.

On the other hand, in S536, the storage cooperating apparatus 400 stores “none” as the logical volume ID of the replication source volume of the mapping information, and stores the volume ID of the volume currently being selected, as the physical volume ID of the replication source volume 4162 of the mapping information 416.

The processing thereafter proceeds to the replication destination volume creation processing S515 in FIG. 5A.

FIG. 5E is a flowchart of assistance in explaining the replication destination volume creation processing S515 in FIG. 5A.

First, in S541, the storage cooperating apparatus 400 makes the DB staticized by instructing the host apparatus 100 to staticize the DB that is the container software of the replication source container 11a.

The following loop processing of S542S to S542E is processing that the storage cooperating apparatus 400 repeatedly performs while sequentially selecting the replication source volumes (physical volumes) in the mapping information 416.

First, in S543, the storage cooperating apparatus 400 instructs the storage apparatus 200 to create a replication destination volume (physical volume) corresponding to the replication source volume (physical volume) of the volume ID currently being selected.

Next, the storage cooperating apparatus 400 determines whether or not the replication source volume of the volume ID currently being selected is a data replication requiring volume (S544). Incidentally, the storage cooperating apparatus 400 makes the above-described determination on the basis of information which indicates the data replication requiring volume and which is prepared and stored in advance, for example. In addition, for example, the storage cooperating apparatus 400 makes the above-described determination on the basis of information which indicates correspondence between the data type of the DB and the necessity or unnecessity of replicating data and which is prepared and stored in advance.

When the replication source volume currently being selected is a data replication requiring volume (S544: Yes), the processing proceeds to S545. When the replication source volume currently being selected is not a data replication requiring volume (S544: No), on the other hand, the processing proceeds to S546.

In S545, the storage cooperating apparatus 400 requests that the storage apparatus 200 replicate the data of the replication source volume currently being selected into the replication destination volume, and the storage apparatus 200 performs the above-described replication according to the above-described request.

In S546, on the basis of the replication destination volume information sent from the storage apparatus 200, the storage cooperating apparatus 400 stores the volume ID of the created replication destination volume (physical volume) in the replication destination volume 4163 of the mapping information 416.

In S547, the storage cooperating apparatus 400 releases the staticization of the DB by transmitting an instruction to release the staticization of the DB of the replication source container 11b to the host apparatus 100.

The processing thereafter proceeds to the container setting information update processing S516 in FIG. 5A.

FIG. 5F is a flowchart of assistance in explaining the container setting information update processing S516 in FIG. 5A.

First, the storage cooperating apparatus 400 obtains the path/volume information of the replication destination container 11b from the host apparatus 100 (S551).

The following loop processing of S552S to S552E is processing that the storage cooperating apparatus 400 repeatedly performs while sequentially selecting the path 4161 of the mapping information 416.

First, the storage cooperating apparatus 400 determines whether or not the replication source volume associated with the path currently being selected is a logical volume (S553). When the replication source volume associated with the path currently being selected is a logical volume (S553: Yes), the processing proceeds to S554. When the replication source volume associated with the path currently being selected is not a logical volume (S553: No), on the other hand, the processing proceeds to S556.

In S554, the storage cooperating apparatus 400 accesses the host apparatus 100, and deletes (a row of) the path currently being selected, from the path information of the path/volume information of the replication destination container 11b.

Next, the storage cooperating apparatus 400 accesses the container operation managing apparatus 300, and adds logical volume setting processing (specifically, a code of the logical volume setting processing) to the container setting information 311 (S555). Incidentally, the addition of the logical volume setting processing to the container setting information 311 may be performed by transmission of the contents of the logical volume setting processing from the storage cooperating apparatus 400 to the container operation managing apparatus 300 and addition, to the container setting information 311 by the container operation managing apparatus 300, of the logical volume setting processing received from the storage cooperating apparatus 400.

On the other hand, in S556, the storage cooperating apparatus 400 accesses the host apparatus 100, and rewrites the physical volume ID of the path currently being selected in the path information of the replication destination container 11b with the volume ID of the replication destination volume.

The processing thereafter proceeds to S517 in FIG. 5A.

### Example of Container Setting Information Update Processing

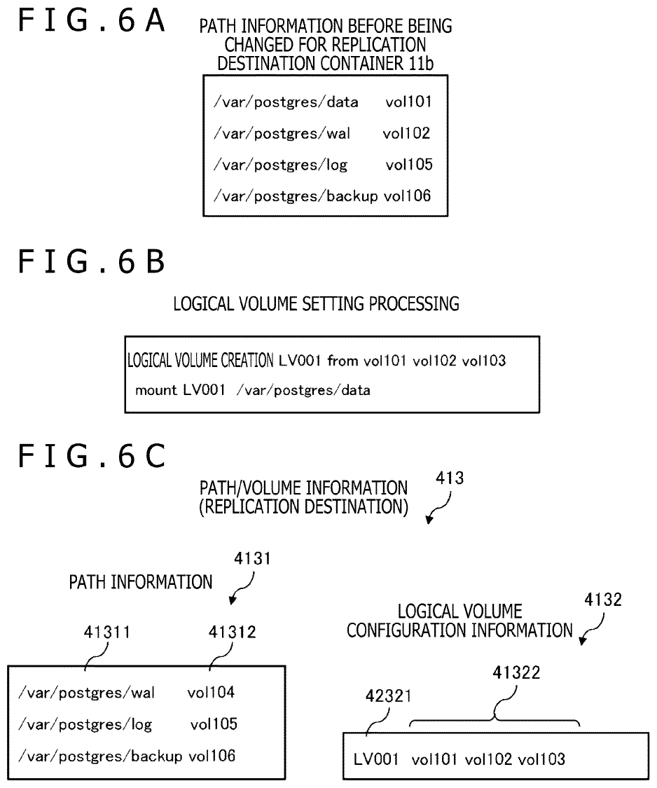

Next, with reference to FIGS. 6A to 6C, a description will be made of a process in which the path/volume information of the host apparatus 100 is set by deploying the replication destination container 11b by the processing of S517 in FIG. 5A on the basis of the container setting information 114 updated by the container setting information update processing S516 illustrated in FIG. 5F.

Incidentally, suppose that, at a time of a start of the container setting information update processing S516, the path/volume information 413 of the replication source container 11a has the contents illustrated in FIG. 4B and that the mapping information has the contents illustrated in FIG. 4C.

FIG. 6A represents an example of path information before being changed for the replication destination container 11b immediately after the replication destination volume creation processing S515 illustrated in FIG. 5E is performed (path information in the path/volume information of the replication destination container 11b which path information corresponds to the path information 4131 illustrated in FIG. 4B).

In this stage, the configuration of logical volumes is not yet reflected in the container setting information 114, and only a replication destination volume (physical volume) “vol101” created in such a manner as to correspond to the physical volume “vol001” of the replication source volume 4162 is associated with a path “/var/postgres/data” associated with a replication source logical volume “LV001.” In addition, replication destination volumes (physical volumes) “vol102,” “vol105,” and “vol106” created in such a manner as to correspond to the replication source volumes (physical volumes) are respectively associated with a path “/var/postgres/wal,” a path “/var/postgres/log,” and a path “/var/postgres/backup.”

FIG. 6B represents an example of the logical volume setting processing added to the container setting information. When the logical volume setting processing is performed at a time of, for example, deployment or starting of the replication destination container 11b, the logical volume “LV001” constituted by the physical volumes “vol101,” “vol102,” and “vol103” of the replication destination container 11b is defined, and the replication destination logical volume “LV001” is associated with the path “/var/postgres/data” in the path information of the replication destination container 11b.

FIG. 6C represents the path/volume information of the replication destination container 11b after the logical volume setting processing is performed. In the path information 4131, the row of the path “/var/postgres/data” in FIG. 6A is deleted. In addition, information indicating correspondence between the logical volume “LV001” and the physical volumes “vol101,” “vol102,” and “vol103” constituting the logical volume is set in the logical volume configuration information 4132.

### Backup Function

Incidentally, the storage system 1 not only has the functions illustrated in the foregoing but also has a function of obtaining a backup of the volumes of the storage apparatus 200 used by the container 11 and restoring the volumes at a time of a fault, a disaster, or the like (which function will hereinafter be referred to as a “backup/restoration function”).

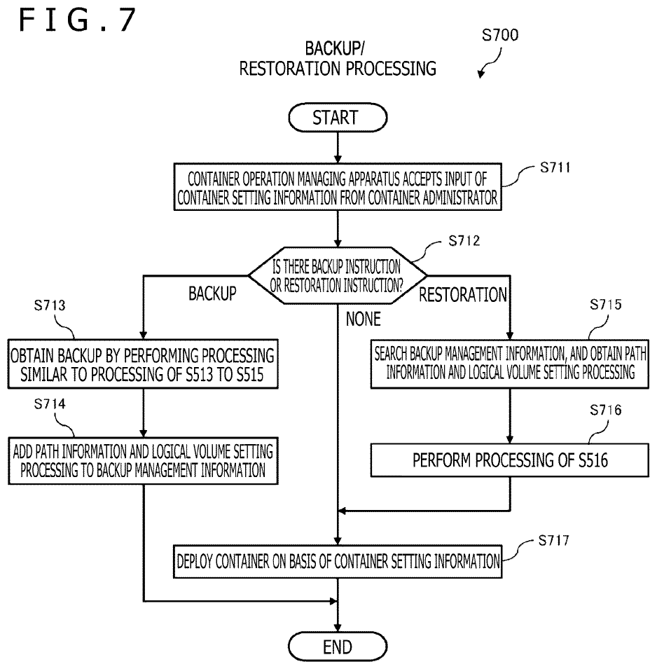

FIG. 7 is a flowchart of assistance in explaining main processing performed in the storage system 1 with regard to the backup/restoration function (which processing will hereinafter be referred to as “backup/restoration processing S700”). In the following, the backup/restoration processing S700 will be described in conjunction with the figure.

First, the container operation managing apparatus 300 accepts an input of container setting information from the container administrator at a time of deployment of a container 11 in the container environment (S711).

The container operation managing apparatus 300 determines whether or not the accepted container setting information is accompanied by an instruction to back up the volumes of the storage apparatus 200 used by the container 11 or an instruction to restore the volumes (S712). Incidentally, when the received container setting information is accompanied by the restoration instruction, information that can identify a backup (generation) used for the restoration (which information will hereinafter be referred to as “backup ID”) is further attached to the accepted container setting information.

When the container setting information is accompanied by the backup instruction (S712: backup), the processing proceeds to S713. In addition, when the container setting information is accompanied by the restoration instruction (S712: restoration), the processing proceeds to S715. When the container setting information is accompanied by none of the backup instruction and the restoration instruction (S712: none), on the other hand, the processing proceeds to S717.

In S713, in the storage system 1, the backup is obtained (replication destination volumes in which the data of volumes (replication source volumes) as a target of the backup is replicated are generated) by performing processing similar to processing of S513 to S515 in the replication destination container deployment processing S500 illustrated in FIG. 5A.

In S714, the backup/restoration processing section 465 of the storage cooperating apparatus 400 adds, to the backup management information 417, a record in which the path information and the logical volume setting processing of the replication destination container 11b are set. The backup/restoration processing S700 is then ended.

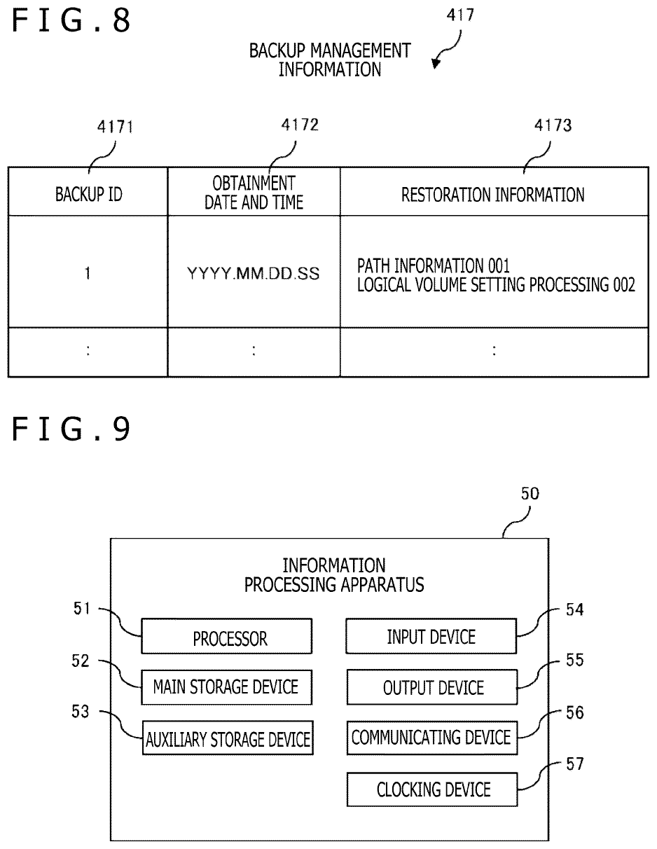

FIG. 8 illustrates an example of the backup management information 417. The backup management information 417 is generated for each container 11 (with a container ID attached) deployed in the container environment of the host apparatus 100.

As illustrated in the figure, the illustrated backup management information 417 is constituted by records generated for respective backups (respective generations), the records having respective items of a backup ID 4171, obtainment date and time 4172, and restoration information 4173.

Of the above-described items, the backup ID 4171 stores a backup ID.

The obtainment date and time 4172 stores date and time of obtainment of the backup of the relevant record.

The restoration information 4173 stores the path information and the logical volume setting processing of the replication destination container 11b.

Described with reference to FIG. 7 again, in S715, the backup/restoration processing section 465 of the storage cooperating apparatus 400 identifies, from the backup management information 417, a record in which the backup ID accompanying the restoration instruction is stored as the backup ID 4171, and obtains the contents (the path information and the logical volume setting processing) of the restoration information 4173 of the identified record.

Incidentally, the storage cooperating apparatus 400 may accept the obtainment date and time of the backup specified by the container administrator or the like from the container operation managing apparatus 300, identify a record in the backup management information 417 in which record the accepted obtainment date and time is stored in the obtainment date and time 4172, and obtain the contents of the restoration information 4173 in the identified record.

Next, the storage cooperating apparatus 400 updates the container setting information by performing the container setting information update processing S516 in FIG. 5A by use of the obtained path information and the obtained logical volume setting processing, and thereby allows the container 11 to use the replication destination volumes (volumes storing data obtained by the backup) (S716).

In S717, the container operation managing apparatus 300 starts the container 11 on the basis of the updated container setting information.

This ends the backup/restoration processing S700.

### Example of Information Processing Apparatus

FIG. 9 illustrates an example of a hardware configuration of an information processing apparatus used for the configuration of each element in the storage system 1. The host apparatus 100, the container operation managing apparatus 300, and the storage cooperating apparatus 400 are implemented by use of the information processing apparatus having the illustrated configuration, for example.

As illustrated in the figure, the illustrated information processing apparatus 50 includes a processor 51, a main storage device 52, an auxiliary storage device 53, an input device 54, an output device 55, a communicating device 56, and a clocking device 57.

Specific examples of the information processing apparatus 50 include, for example, a personal computer, an office computer, various types of server apparatuses, a general-purpose machine, and the like.

The information processing apparatus 50 may be implemented by use of virtual information processing resources provided by use of a virtualization technology, a process space separation technology, or the like, as in a virtual server, all or a part of which is provided by a cloud system, for example.

Each constituent element of the storage system 1 may be implemented by, for example, use of a plurality of information processing apparatuses 50 communicably connected to each other.

In the figure, the processor 51 is constituted by use of, for example, a CPU, an MPU, a GPU, an FPGA, an ASIC, an AI chip, or the like.

The main storage device 52 is a device for storing programs and data, and is, for example, a read only memory (ROM), a random access memory (RAM), a nonvolatile memory (non volatile RAM (NVRAM)), or the like.

The auxiliary storage device 53 is, for example, a reading/writing device for a recording medium such as an SSD, an HDD, an optical storage device (a compact disc (CD), a digital versatile disc (DVD), or the like), a storage system, an integrated circuit (IC) card, a secure digital (SD) card, or an optical recording medium, a storage area of a cloud server, or the like. A program or data can be read into the auxiliary storage device 53 via the reading device for the recording medium or the communicating device 56. The program or the data stored in the auxiliary storage device 53 is read into the main storage device 52 as needed.

The input device 54 is an interface for accepting an external input, and is, for example, a keyboard, a mouse, a touch panel, a card reader, a pen input type tablet, a voice input device, or the like.

The output device 55 is an interface for outputting various types of information such as the progress of processing and a processing result. The output device 55 is, for example, a display device (a liquid crystal display (LCD), a graphics card, or the like) for converting the above-described various types of information into a visual form, a device (audio output device (speaker or the like)) for converting the above-described various types of information into sound, or a device (printing device or the like) for converting the above-described various types of information into characters. Incidentally, for example, the information processing apparatus 50 may be configured to perform information input and output with another apparatus via the communicating device 56.

The input device 54 and the output device 55 constitute a user interface for accepting information from and presenting information to a user.

The communicating device 56 is a device for implementing communication (wire communication or wireless communication) with another apparatus via a communication base such as the communication network 5 or a communication network 6. The communicating device 56 is configured by use of, for example, a network interface card (NIC), a wireless communication module, a universal serial bus (USB) module, or the like.

The clocking device 57 is implemented by use of, for example, a mechanism of a real time clock (RTC) or a network time protocol (NTP). The clocking device 57 generates information indicating date and time and an accurate timing.

Incidentally, an operating system, a file system, a database management system (DBMS) (relational database, NoSQL, or the like), a key-value store (KVS), or the like, for example, may be introduced into the information processing apparatus 50.

Functions that each constituent element of the storage system 1 has are implemented by the processor 51 of the information processing apparatus 50 reading and executing a program stored in the main storage device 52 or by functions of hardware (the FPGA, the ASIC, the AI chip, or the like) itself constituting the information processing apparatus 50. The information processing apparatus 50 stores various types of information (data) as a table in a database or a file managed by a file system, for example.

Incidentally, two or more of the host apparatus 100, the container operation managing apparatus 300, and the storage cooperating apparatus 400 may be configured to be implemented by a common information processing apparatus 50.

### Technical Effects and Others

As described above, in the storage system 1 according to the present embodiment, the storage cooperating apparatus 400 (information processing apparatus) obtains the path/volume information of a container (server) from the host apparatus 100 (external apparatus), identifies a replication source volume used by the software executed by the replication source container (replication source server), on the basis of the obtained path/volume information, transmits a request to create a replication destination volume corresponding to the replication source volume to the storage apparatus 200, generates the mapping information that is information indicating correspondence between the replication destination volume and a path, on the basis of the obtained path/volume information and the replication destination volume information, and updates information identifying the replication source volume in the container setting information (server setting information) that is setting information in the server environment of the replication destination server to information identifying the replication destination volume on the basis of the generated mapping information.

Therefore, the container administrator and the storage administrator do not need to perform complex work in replicating the container, so that a burden imposed on the container administrator and the storage administrator in replicating the container can greatly be reduced.

In addition, in a case where a path in the path/volume information is associated with a replication source logical volume that is a logical volume configured by use of a plurality of volumes, the storage cooperating apparatus 400 (information processing apparatus) adds, to the container setting information (server setting information), logical volume setting processing that is processing of setting, in the server setting information, information indicating correspondence between replication destination volumes created in the storage apparatus 200 in such a manner as to correspond to the volumes constituting the replication source logical volume and a replication destination logical volume that is a logical volume used by the replication destination server in such a manner as to correspond to the replication source logical volume, the replication destination logical volume being associated with a path used when the software executed by the replication destination container (replication destination server) accesses the replication destination logical volume.

Therefore, the container administrator and the storage administrator do not need to perform complex work for setting the logical volume for the replication destination container in replicating the container, so that a burden on the container administrator and the storage administrator can be reduced.

In addition, the storage cooperating apparatus 400 (information processing apparatus) determines whether or not there is a necessity for replication of data stored in each replication source volume into the replication destination volume created in the storage apparatus 200 in such a manner as to correspond to the respective replication source volume, on the basis of the path/volume information, and transmits, to the storage apparatus 200, an instruction to replicate the data of a replication source volume for which it is determined that the replication is necessary into the replication destination volume.

Therefore, the container administrator and the storage administrator do not need to perform complex work such as the identification of volumes necessitating replication and the replication of data in replicating the container 11, so that a burden on the container administrator and the storage administrator can be reduced.

In addition, at a time of backup of the volume used by the container (server) deployed in the container environment (server environment) of the host apparatus 100, the storage cooperating apparatus 400 obtains, from the host apparatus 100, path/volume information that is information indicating correspondence between a path used in accessing a replication source volume that is the volume used by software executed by the container corresponding to the replication source of the backup (replication source server) and the replication source volume, transmits a request to create a replication destination volume that is a volume as a replication destination to the storage apparatus 200, receives replication destination volume information that is information identifying the replication destination volume, the replication destination volume information being sent from the storage apparatus 200 in response to the creation request, generates mapping information that is information indicating correspondence between the replication destination volume and the path, on the basis of the path/volume information and the replication destination volume information, generates and stores backup management information including information identifying the replication destination volume, on the basis of the mapping information, and, at a time of restoration, the storage cooperating apparatus 400 updates information identifying the replication source volume in the container setting information to information identifying the replication destination volume in the backup management information on the basis of the backup management information.

Thus, the storage cooperating apparatus 400 automatically performs the backup and restoration of the volume used by the container. The backup and restoration of the volume can therefore be performed easily, so that a burden on the container administrator and the storage administrator can be reduced.

In addition, at the time of the backup, in a case where the path in the path/volume information is associated with a replication source logical volume that is a logical volume configured by use of a plurality of volumes, the storage cooperating apparatus 400 includes, in the backup management information, logical volume setting processing that is processing of setting, in the container setting information (server setting information), information indicating correspondence between replication destination volumes created in the storage apparatus 200 in such a manner as to correspond to the volumes constituting the replication source logical volume and a logical volume, and, at the time of the restoration, the storage cooperating apparatus 400 obtains the logical volume setting processing from the backup management information and adds the obtained logical volume setting processing to the container setting information.

Therefore, at the time of the restoration of the volume used by the container, the container administrator and the storage administrator do not need to perform complex work for setting the logical volume for the replication destination volumes, so that a burden on the container administrator and the storage administrator can be reduced.

In addition, at the time of the backup, the storage cooperating apparatus 400 makes identification information identifying the backup accompany the backup management information, and, at the time of the restoration, the storage cooperating apparatus 400 accepts the identification information of the backup and updates information identifying the replication source volume in the server setting information to information identifying the replication destination volume in the backup management information on the basis of the backup management information identified by the accepted identification information.

Therefore, the container administrator can select a desired backup from among a plurality of backups obtained and restore the volume.

The embodiment of the present invention has been described above. However, the present invention is not limited to the foregoing embodiment, and includes various modifications and is not necessarily limited to the one including all of the described configurations.

For example, in the foregoing, a description has been made by taking as an example a case where the server operating in the host apparatus 100 is a container. However, the present invention is also applicable to a case where the server operating in the host apparatus 100 is a server of a type other than the container, such as a case where the server operating in the host apparatus 100 is, for example, a virtual server deployed in a virtual environment of the host apparatus 100, a physical server deployed in a physical server environment of the host apparatus 100, or the like.

In addition, for example, the volume used by the replication source container (server) and the volume used by the replication destination container (server) may be volumes provided by respective different storage apparatuses 200.

In addition, the container operation managing apparatus 300 may have all or some of the functions that the storage cooperating apparatus 400 has. In addition, conversely, the storage cooperating apparatus 400 may have all or some of the functions of the container operation managing apparatus 300. In addition, the host apparatus 100 may have all or some of the functions that the storage cooperating apparatus 400 and the container operation managing apparatus 300 have.

What is claimed is:

1. An information processing apparatus for assisting in replication of a server configured to use a volume that is a provision unit of a storage area in the storage apparatus and deployed in a server environment of an external apparatus in which the server operates, the replication being performed in a storage system including a storage apparatus configured to input or output data to or from a storage device in response to an input/output request sent from the external apparatus and the external apparatus,
the information processing apparatus being communicably connected to the external apparatus and the storage apparatus, and
the information processing apparatus being configured to
obtain, from the external apparatus, path/volume information that is information indicating correspondence between a path used in accessing a replication source volume that is the volume configured to be used by software configured to be executed by a replication source server that is a server as a replication source and the replication source volume,
transmit, to the storage apparatus, a request to create a replication destination volume that is a volume corresponding to the replication source volume, the replication destination volume being configured to be used by a replication destination server that is a server as a replication destination,
receive replication destination volume information that is information identifying the replication destination volume, the replication destination volume information being sent from the storage apparatus in response to the creation request,
generate mapping information that is information indicating correspondence between the path and the replication destination volume, on a basis of the path/volume information and the replication destination volume information,
store server setting information that is setting information in the server environment of the replication destination server, and
update information identifying the replication source volume in the server setting information to the information identifying the replication destination volume on a basis of the mapping information.

2. The information processing apparatus according to claim 1, wherein,
in a case where the path in the path/volume information is associated with a replication source logical volume that is a logical volume configured by use of a plurality of volumes, the information processing apparatus adds, to the server setting information, logical volume setting processing that is processing of setting, in the server setting information, information indicating correspondence between a plurality of the replication destination volumes created in the storage apparatus in such a manner as to correspond to the volumes constituting the replication source logical volume and a replication destination logical volume that is a logical volume used by the replication destination server in such a manner as to correspond to the replication source logical volume, the replication destination logical volume being associated with a path used when the software executed by the replication destination server accesses the replication destination volumes.

3. The information processing apparatus according to claim 1, wherein
the information processing apparatus determines whether or not there is a necessity for replication of data stored in each replication source volume into the replication destination volume created in the storage apparatus in such a manner as to correspond to the respective replication source volume, on a basis of the path/volume information, and transmits, to the storage apparatus, an instruction to replicate the data of a replication source volume for which it is determined that the replication is necessary into the replication destination volume.

4. The information processing apparatus according to claim 1, wherein
the server is one of
a container deployed in a container environment that is the server environment,
a virtual server deployed in a virtual environment that is the server environment, and
a physical server deployed in a physical server environment that is the server environment.

5. The information processing apparatus according to claim 1, wherein
the information processing apparatus is communicably connected to a server operation managing apparatus configured to manage operation of the server,
the server setting information is setting information of the server input when the server operation managing apparatus deploys the server in the server environment, and
the server is deployed in the server environment on a basis of the server setting information.

6. The information processing apparatus according to claim 1, wherein
the software is a database management system.

7. An information processing apparatus for assisting in backup and restoration of a volume used by a server configured to use the volume that is a provision unit of a storage area in the storage apparatus and deployed in a server environment of an external apparatus in which the server operates, the backup and the restoration being performed in a storage system including a storage apparatus configured to input or output data to or from a storage device in response to an input/output request sent from the external apparatus and the external apparatus,
the information processing apparatus being communicably connected to the external apparatus and the storage apparatus, and
the information processing apparatus being configured to
store server setting information that is setting information of the server in the server environment,
at a time of the backup,
obtain, from the external apparatus, path/volume information that is information indicating correspondence between a path used in accessing a replication source volume that is the volume configured to be used by software configured to be executed by the server and the replication source volume,
transmit, to the storage apparatus, a request to create a replication destination volume that is a volume as a replication destination,
receive replication destination volume information that is information identifying the replication destination volume, the replication destination volume information being sent from the storage apparatus in response to the creation request,
generate mapping information that is information indicating correspondence between the replication destination volume and the path, on a basis of the path/volume information and the replication destination volume information,
generate and store backup management information including the information identifying the replication destination volume, on a basis of the mapping information, and,
at a time of the restoration,
update information identifying the replication source volume in the server setting information to the information identifying the replication destination volume in the backup management information on a basis of the backup management information.

8. The information processing apparatus according to claim 7, wherein,
at the time of the backup,
in a case where the path in the path/volume information is associated with a replication source logical volume that is a logical volume configured by use of a plurality of volumes, the information processing apparatus includes, in the backup management information, logical volume setting processing that is processing of setting, in the server setting information, information indicating correspondence between a plurality of the replication destination volumes created in the storage apparatus in such a manner as to correspond to the volumes constituting the replication source logical volume and a replication destination logical volume that is a logical volume configured by use of the replication destination volumes, and,
at the time of the restoration,
the information processing apparatus obtains the logical volume setting processing from the backup management information and adds the obtained logical volume setting processing to the server setting information.

9. The information processing apparatus according to claim 7, wherein
the information processing apparatus determines whether or not there is a necessity for replication of data stored in each replication source volume into the replication destination volume created in the storage apparatus in such a manner as to correspond to the respective replication source volume, on a basis of the path/volume information, and transmits, to the storage apparatus, an instruction to replicate the data of a replication source volume for which it is determined that the replication is necessary into the replication destination volume.

10. The information processing apparatus according to claim 7, wherein,
at the time of the backup,
the information processing apparatus makes identification information identifying the backup obtained accompany the backup management information, and,
at the time of the restoration,
the information processing apparatus
accepts the identification information, and
updates the information identifying the replication source volume in the server setting information to the information identifying the replication destination volume in the backup management information on a basis of the backup management information identified by the accepted identification information.

11. The information processing apparatus according to claim 10, wherein
the identification information is information indicating obtainment date and time of the backup.

12. The information processing apparatus according to claim 7, wherein
the server is one of
a container deployed in a container environment that is the server environment,
a virtual server deployed in a virtual environment that is the server environment, and
a physical server deployed in a physical server environment that is the server environment.

13. The information processing apparatus according to claim 7, wherein
the information processing apparatus is communicably connected to a server operation managing apparatus configured to manage operation of the server,
the server setting information is setting information of the server input when the server operation managing apparatus deploys the server in the server environment, and
the server is deployed in the server environment on a basis of the server setting information.

14. An information processing method for assisting in replication of a server configured to use a volume that is a provision unit of a storage area in the storage apparatus and deployed in a server environment of an external apparatus in which the server operates, the replication being performed in a storage system including a storage apparatus configured to input or output data to or from a storage device in response to an input/output request sent from the external apparatus and the external apparatus,
the information processing method being performed by an information processing apparatus communicably connected to the external apparatus and the storage apparatus, the information processing method comprising:
obtaining, from the external apparatus, path/volume information that is information indicating correspondence between a path used in accessing a replication source volume that is the volume configured to be used by software configured to be executed by a replication source server that is a server as a replication source and the replication source volume;
transmitting, to the storage apparatus, a request to create a replication destination volume that is a volume corresponding to the replication source volume, the replication destination volume being configured to be used by a replication destination server that is a server as a replication destination;
receiving replication destination volume information that is information identifying the replication destination volume, the replication destination volume information being sent from the storage apparatus in response to the creation request;
generating mapping information that is information indicating correspondence between the path and the replication destination volume, on a basis of the path/volume information and the replication destination volume information;
storing server setting information that is setting information in the server environment of the replication destination server; and
updating information identifying the replication source volume in the server setting information to the information identifying the replication destination volume on a basis of the mapping information.

15. The information processing method according to claim 14, further comprising:
by the information processing apparatus,
in a case where the path in the path/volume information is associated with a replication source logical volume that is a logical volume configured by use of a plurality of volumes, adding, to the server setting information, logical volume setting processing that is processing of setting, in the server setting information, information indicating correspondence between a plurality of the replication destination volumes created in the storage apparatus in such a manner as to correspond to the volumes constituting the replication source logical volume and a replication destination logical volume that is a logical volume used by the replication destination server in such a manner as to correspond to the replication source logical volume, the replication destination logical volume being associated with a path used when the software executed by the replication destination server accesses the replication destination volumes.
